(19) United States
(12) Patent Application Publication
(10) Pub. No.: US 2012/0158195 A1
(43) Pub. Date: Jun. 21, 2012

(54) METHOD OF CONTROLLING DISTRIBUTION OF ELECTRIC POWER IN SMART GRID AND APPARATUS THEREFOR

(75) Inventors: Sun Me KIM, Daejeon (KR); Ho Young SONG, Daejeon (KR)

(73) Assignee: ELECTRONICS AND TELECOMMUNICATIONS RESEARCH INSTITUTE, Daejeon (KR)

(21) Appl. No.: 13/325,566

(22) Filed: Dec. 14, 2011

(30) Foreign Application Priority Data
Dec. 16, 2010 (KR) 10-2010-0129482

(51) Int. Cl. G06F 1/26

(52) U.S. Cl. 700/286

(57) ABSTRACT

Provided are a method of controlling distribution of electric power using hierarchical identifiers in a smart grid and an apparatus therefor. The apparatus may include a first extractor configured to extract a production node capable of accepting a power request with reference to at least one demand node using hierarchical identifiers of the production node and the demand node when the power request is received from the demand node, the demand node being connected to a plurality of layers via distribution nodes; a second extractor configured to extract distribution nodes on distribution routes from the production node to the demand node using the hierarchical identifier of the demand node and the hierarchical to identifier of the production node; and a controller configured to control the distribution nodes on the distribution routes from the production node to the demand node using hierarchical identifiers of the distribution nodes.

### CLAIM FOR PRIORITY

This application claims priority to Korean Patent Application No. 10-2010-0129482 filed on Dec. 16, 2010 in the Korean Intellectual Property Office (KIPO), the entire contents of which are hereby incorporated by reference.

### BACKGROUND

1. Technical Field

Example embodiments of the present invention relate to a method of controlling distribution of electric power in a smart grid and an apparatus therefor, and more particularly, to a method of controlling distribution of electric power using hierarchical identifiers in a smart grid and an apparatus therefor.

2. Related Art

In general, electric energy can be obtained from power plants using fossil raw materials, nuclear power, water power, etc. Fossil raw materials, which are primary raw materials in power plants for producing energy, create carbon dioxide, which causes environmental issues. Fossil raw materials are currently being exhausted. Further, since it is difficult to store the electrical energy, which must be consumed as soon as it is generated, power plants are built when a power consumption amount reaches a maximum value.

Since power plants are closed and independently managed, power plants are hardly used when a consumption amount of electric power is small. Thus, power plants are inefficient. For this reason, there is a problem in that a user cannot recognize how much electricity he or she is using, but can only confirm electricity fees from a monthly issued bill. A smart grid has been introduced in order to solve such a problem.

A smart grid is an intelligent power network that achieves optimized energy efficiency through integration of IT technology into an existing power system. That is, the smart grid is an intelligent power network that achieves optimized energy efficiency by bidirectionally exchanging real-time information between a producer for producing electric power and a consumer through integration of IT technology into an existing unidirectional power system.

The smart grid network can monitor and control distribution of electric power from a production node to a demand node. However, production, demand, and distribution nodes of the smart grid network do not have unique identifiers or are identified using Internet protocol version (IPv) 4/IPv6 addresses or MAC addresses in an in-house network or a power network. For this reason, it is not possible to trace addresses or positions of nodes of the smart grid network and it is difficult to recognize distribution routes from the production node to the demand node due to automation of the smart grid network, making it impossible to control the distribution of electric power.

### SUMMARY

Accordingly, example embodiments of the present invention are provided to substantially obviate one or more problems due to limitations and disadvantages of the related art.

Example embodiments of the present invention provide a method of identifying production, demand and distribution nodes and managing a power distribution connection relationship between the nodes by applying hierarchical identifiers to a smart grid system.

Example embodiments of the present invention also provide a method capable of automatically selecting an optimal production node in real time using a hierarchical identifier structure in response to a request from a demand node that requests real-time power in a smart grid network.

Example embodiments of the present invention also provide a method of automatically recognizing power distribution routes from a production node to a demand node using a hierarchical identifier structure, automatically calculating distribution nodes on the power distribution route, and performing real-time power distribution control.

In some example embodiments, a smart grid node is any apparatus that defines and has an identifier including a power distribution route identifier for hierarchically identifying power distribution routes along a power distribution path having a tree structure, and an apparatus identifier indicating a unique ID capable of identifying an individual apparatus in a last power distribution route layer.

In other example embodiments, an apparatus for controlling distribution of electric power includes: a first extractor configured to extract a production node capable of accepting a power request with reference to at least one demand node using hierarchical identifiers of the production node and the demand node when the power request is received from the demand node, the demand node being connected to a plurality of layers via distribution nodes; a second extractor configured to extract distribution nodes on distribution routes from the production node to the demand node using the hierarchical identifier of the demand node and the hierarchical identifier of the production node; and a controller configured to control the distribution nodes on the distribution routes from the production node to the demand node using hierarchical identifiers of the distribution nodes.

In still other example embodiments, a method of controlling distribution of electric power includes: receiving a power request from at least one demand node connected to a plurality of layers via distribution nodes; extracting a production node capable of accepting the power request with reference to the demand node using hierarchical identifiers of the production node and the demand node; extracting distribution nodes on distribution routes from the production node to the demand node using the hierarchical identifier of the demand node and the hierarchical identifier of the production node; and controlling the distribution nodes on the distribution routes from the production node to the demand node using hierarchical identifiers of the distribution nodes.

### BRIEF DESCRIPTION OF DRAWINGS

Example embodiments of the present invention will become more apparent by describing in detail example embodiments of the present invention with reference to the accompanying drawings, in which:

FIG. 1 is a block diagram showing a structure of a smart grid according to an example embodiment of the present invention;

FIG. 2 illustrates a process in which hierarchical identifiers are defined by a definition unit of a power production, demand and distribution apparatus in a smart grid according to an example embodiment of the present invention.

FIG. 3 shows structures of the hierarchical identifiers defined by the definition unit of the power production, demand and distribution apparatus in the smart grid according to an example embodiment of the present invention;

FIG. 4 shows structures of the hierarchical identifiers defined by the definition unit of the power production, demand and distribution apparatus in the smart grid according to an example embodiment of the present invention;

FIG. 5 schematically shows an internal structure of a power distribution control apparatus for controlling a power distribution network between a production node and a demand node using hierarchical identifiers defined by the definition unit in a smart grid network according to an example embodiment of the present invention;

FIG. 6 is a flowchart illustrating power distribution control for controlling distribution of electric power between a production node and a demand node according to an example embodiment of the present invention;

FIG. 7 is a flowchart illustrating a power distribution control process for controlling distribution of electric power between a production node and a demand node according to an example embodiment of the present invention;

FIG. 8 is a flowchart illustrating a process of extracting an optimal production node when there is a power request from a demand node in a smart grid according to an example embodiment of the present invention; and

FIG. 9 is a flowchart illustrating a process of extracting an optimal production node among production nodes stored in a produced power information database when a power distribution control apparatus receives a power request from a demand node and controlling distribution of electric power between the demand node and the production node according to an example embodiment of the present invention.

### DESCRIPTION OF EXAMPLE EMBODIMENTS OF THE PRESENT INVENTION

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, example embodiments of the present invention will be described in greater detail with reference to the accompanying drawings.

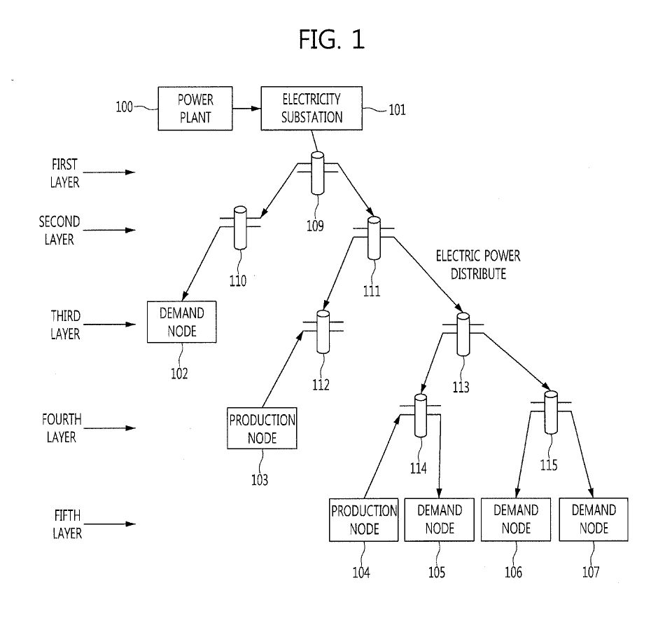

FIG. 1 is a block diagram showing a structure of a smart grid according to an example embodiment of the present invention. In FIG. 1, a power distribution network to which the smart grid has been applied includes five layers. When the number of layers in an internal structure of the power distribution network is changed, the internal structure of the power distribution network may be changed according to the changed number of layers.

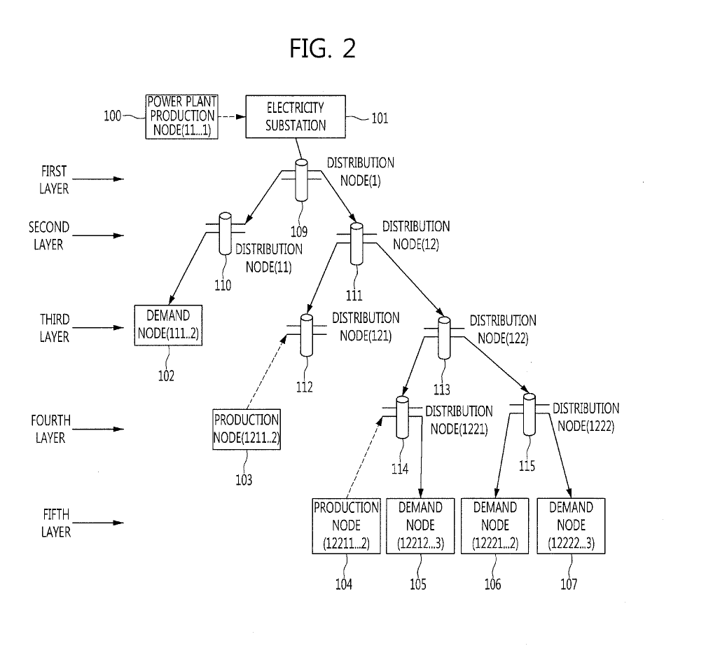

Referring to FIG. 1, the power distribution network in the smart grid that distributes electric power may include first to fifth layers each including any of demand nodes 102, 105 and 107, production nodes 103, 104 and 106, and distribution nodes 109, . . . , 115. Electric power from a power plant 110 or the distributive power production nodes 103, 104 and 106 is delivered to the demand nodes 102, 105 and 107 via the distribution nodes 109, . . . , 115. In the smart grid, the most optimal production nodes 103, 104 and 106 are selected in response to a power request made in real time from the demand nodes 102, 105 and 107, and distribution of electric power from the production nodes 103, 104 and 106 to the demand nodes 102, 105 and 107 is automatically controlled in real time. Thus, it is possible to reduce energy loss and increase energy efficiency by positively using distributive power. Hereinafter, a process in which hierarchical identifiers are defined by a definition unit (not shown) of a power production, demand and distribution apparatus in a smart grid according to an example embodiment of the present invention will be described in greater detail with reference to FIG. 2.

FIG. 2 illustrates a process in which hierarchical identifiers are defined by a definition unit (not shown) of a power production, demand and distribution apparatus in a smart grid according to an example embodiment of the present invention. In FIG. 2, an internal structure of a power distribution network to which a smart grid has been applied includes five layers. When the number of layers in the internal structure of the power distribution network is changed, the internal structure of the power distribution network may be changed according to the changed number of layers.

Referring to FIG. 2, the definition unit (not shown) of the power production, demand and distribution apparatus in the smart grid network defines hierarchical identifiers that can hierarchically identify power distribution routes along a power distribution path having a tree structure. Here, the hierarchical identifier may include a power distribution route identifier for hierarchically identifying distribution routes of N layers (N is a natural number), and an apparatus identifier for uniquely identifying an apparatus in a last layer.

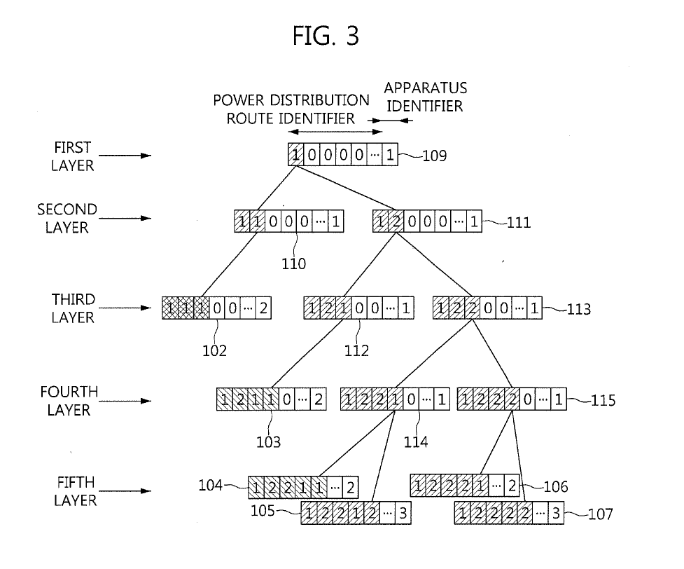

According to an example embodiment of the present invention, if the definition unit defines the hierarchical identifier of the demand node 102 as “111 . . . 2,” the demand node 102 is defined as the demand node 102 present in the third layer that is supplied with electric power via distribution node 1 109 of the first layer and distribution node 11 110 of the second layer. Further, according to an example embodiment of the present invention, if the definition unit defines the hierarchical identifier of the production node 103 as “1211 . . . 2,” the production node 103 is defined as the production node 103 of the fourth layer connected to the power network that supplies electrical power via the distribution node 1 109 of the first layer, the distribution node 12 111 of the second layer, and the distribution node 121 112 of the third layer. Hereinafter, structures of the hierarchical identifiers defined by the definition unit of the power production, demand and distribution apparatus in the smart grid according to an example embodiment of the present invention will be described in greater detail with reference to FIG. 3.

FIG. 3 shows structures of hierarchical identifiers defined by the definition unit of the power production, demand and distribution apparatus in the smart grid according to an example embodiment of the present invention. In FIG. 3, the internal structure of the power distribution network to which the smart grid has been applied includes five layers. When the number of layers in the internal structure of the power distribution network is changed, the internal structure of the power distribution network may be changed according to the changed number of layers.

Referring to FIG. 3, the hierarchical identifier defined by the definition unit of the power production, demand and distribution apparatus in the smart grid may include a power distribution route identifier for hierarchically identifying distribution routes of N layers (N is a natural number), and an apparatus identifier for uniquely identifying an apparatus in a last layer. Further, the power distribution route identifier has a hierarchical identifier structure to which power distribution route layers having a tree structure are directly applied. In the hierarchical tree, a layer corresponding to a layer value first having 0 minus 1 is a layer to which a node belongs, and nodes in each layer are identified by unique node identifiers.

Accordingly, based only on the hierarchical identifier of each node, a position of the node and distribution routes on the power distribution network are automatically recognized, and information of the distribution nodes 109, . . . , 115 on the distribution routes from the production nodes 103, 104 and 106 to the demand nodes 102, 105 and 107 can also be automatically recognized.

That is, when power distribution from the production node 103 to the demand node 105 must be controlled, layer-specific values of the hierarchical identifier “1211 . . . 2” of the production node 103 defined by the definition unit are compared with layer-specific values of the hierarchical identifier “1222 . . . 3” of the demand node 105 defined by the definition unit, and a third layer, which is a first mismatched bottom layer, is selected. If power distribution for the distribution nodes 114 and 115 from the distribution node 112 in the third layer to which the production node 103 belongs, the distribution node 111 of the second layer that is an upper distribution node of the distribution node 112 in the third layer, and the distribution node 113 in the third layer to which the demand node 105 belongs, to the demand node 105 is controlled, automatic distribution of electric power is possible.

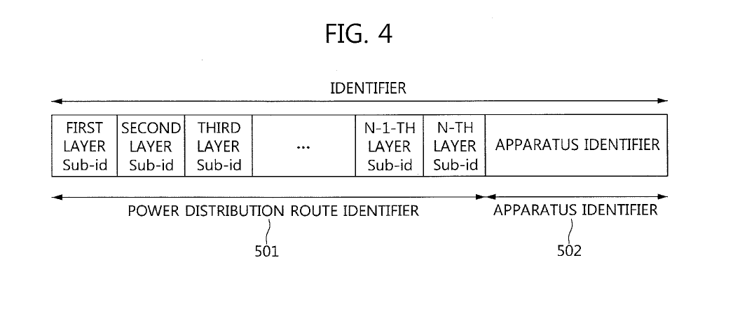

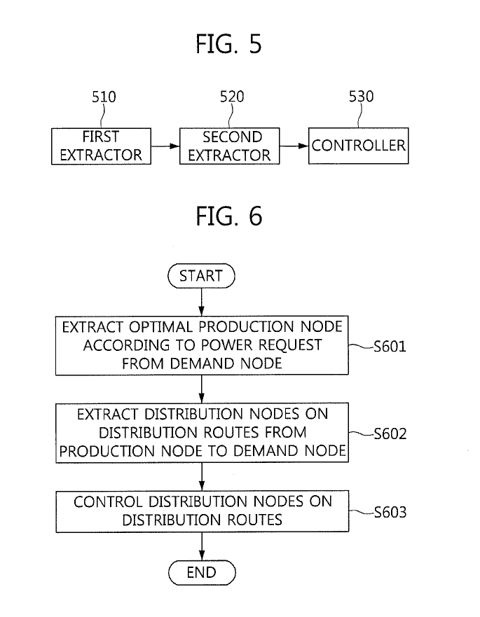

A structure of the hierarchical identifier defined for each node by the definition unit will be described in greater detail with reference to FIG. 4. The hierarchical identifier includes a power distribution route identifier 501 and a node identifier 502. The power distribution route identifier 501 is an identifier that can hierarchically identify power distribution routes along a power distribution path having a hierarchical structure. The node identifier 502 is a unique identifier for identifying an individual apparatus in a power distribution route layer. The power distribution route identifier 501 includes information for a plurality of distribution nodes included in distribution routes from a production node to a demand node. According to an example embodiment of the present invention, the power distribution network includes a first layer to an N-th layer. When a production node included in the first layer supplies electric power to a demand node included in the N-th layer, the power distribution route identifier 501 includes identifiers of distribution nodes included in the respective layers. Hereinafter, an internal structure of a power distribution control apparatus for controlling distribution of electric power between the production node and the demand node using hierarchical identifiers defined by the definition unit in the smart grid according to an example embodiment of the present invention will be described in greater detail with reference to FIG. 5.

FIG. 5 schematically shows an internal structure of a power distribution control apparatus for controlling a power distribution network between a production node and a demand node using hierarchical identifiers defined by the definition unit in a smart grid network according to an example embodiment of the present invention.

Referring to FIG. 5, the power distribution control apparatus may include a first extractor 501, a second extractor 502, and a controller 503. The first extractor 501 receives a request for electric power from at least one demand node connected to a plurality of layers via distribution nodes. In this case, first, the first extractor 501 extracts production nodes that can accept the power request with reference to the demand node using the hierarchical identifier defined for the demand node by the definition unit and the hierarchical identifiers of the production nodes connected to the plurality of layers via the distribution nodes. If the first extractor 501 determines that there is at least one production node that can accept the power request with reference to the demand node, the first extractor 501 sequentially compares digits of the hierarchical identifier of the demand node with digits of the hierarchical identifiers of the production nodes connected to the plurality of layers via the distribution nodes and extracts the production node corresponding to the hierarchical identifier having the most matched digits.

According to an example embodiment of the present invention, if the first extractor 501 receives a request for 80 kW power from the demand node having a hierarchical identifier of “12221 . . . 2” defined by the definition unit and determines that there are first to third production nodes that can accept the 80 kW power request with reference to the demand node, first, the first extractor 501 sequentially compares digits of the hierarchical identifier “12221 . . . 2” of the demand node with digits of the hierarchical identifier of the first production node “11 . . . 1” and determines that the hierarchical identifiers are the same in the first digit. Second, the first extractor 501 sequentially compares the digits of the hierarchical identifier “12221 . . . 2” of the demand node with digits of the hierarchical identifier “1211 . . . 2” of the second production node and determines that the hierarchical identifiers are the same in the first and second digits. Third, the first extractor 501 sequentially compares the digits of the hierarchical identifier “12221 . . . 2” of the demand node with digits of the hierarchical identifier “12211 . . . 2” of the third production node and determines that the hierarchical identifiers are the same in the first, second, and third digits. Thus, the first extractor 501 sequentially compares the digits and extracts the third production node having the most matched digits from among the first to third production nodes that can accept the 80 kW power request with reference to the demand node.

Using the hierarchical identifier of the production node extracted by the first extractor 501 and the hierarchical identifier of the demand node that has transmitted the power request, the second extractor 502 extracts distribution nodes on distribution routes from the production node to the demand node. According to an example embodiment of the present invention, if the hierarchical identifier of the production node extracted by the first extractor 501 is “1211 . . . 2” and the hierarchical identifier of the demand node that has made the power request is “12221 . . . 2,” the second extractor 102 sequentially compares a power distribution route identifier of the hierarchical identifier of the demand node with a power distribution route identifier of the hierarchical identifier of the production node, from a top layer. If at least one power distribution route is mismatched, the second extractor 102 extracts the third digit corresponding to the mismatched layer.

The controller 503 controls the distribution nodes on the distribution routes from the production node to the demand node using the hierarchical identifiers of the distribution nodes on the distribution routes extracted by the second extractor 502. According to an example embodiment of the present invention, if the hierarchical identifier of the production node extracted by the first extractor 501 is “1211 . . . 2” and the hierarchical identifier of the demand node that has made the power request is “12221 . . . 2,” the controller 503 controls the distribution nodes extracted by the second extractor 502, i.e., distribution nodes included in a layer directly before the layer including the production node to the third layer, the distribution node included in the second layer, and distribution nodes included in the fourth layer to a layer directly before a layer including the demand node. Hereinafter, a distribution control method of controlling distribution of electric power between the production node and the demand node according to an example embodiment of the present invention will be described in greater detail with reference to FIG. 6.

FIG. 6 is a flowchart illustrating power distribution control for controlling distribution of electric power between the production node and the demand node according to an example embodiment of the present invention.

Referring to FIG. 6, the power distribution control apparatus receives a power request from at least one demand node connected to the plurality of layers via the distribution nodes (S601). The power distribution control apparatus extracts production nodes that can accept the power request with reference to the demand node using hierarchical identifiers of production nodes and the demand node (S602). First, the power distribution control apparatus extracts production nodes that can accept the power request with reference to the demand node using hierarchical identifiers defined for the demand node and the hierarchical identifiers of the production nodes connected to the plurality of layers via the distribution nodes. If the power distribution control apparatus determines that there is at least one production node that can accept the power request with reference to the demand node, the power distribution control apparatus sequentially compares digits of the hierarchical identifier of the demand node and digits of the hierarchical identifiers of the production nodes connected to the plurality of layers via the distribution nodes and extracts the production node corresponding to the hierarchical identifier having more matched digits.

According to an example embodiment of the present invention, if the power distribution control apparatus receives a request for 80 kW power from the demand node having a hierarchical identifier of “12221 . . . 2” defined by the definition unit and determines that there are first to third production nodes that can accept the 80 kW power request with reference to the demand node, first, the power distribution control apparatus sequentially compares digits of the hierarchical identifier “12221 . . . 2” of the demand node with digits of the hierarchical identifier “11 . . . 1” of the first production node and determines that the hierarchical identifiers are the same in the first digits. Second, the power distribution control apparatus sequentially compares the digits of the hierarchical identifier “12221 . . . 2” of the demand node with digits of the hierarchical identifier “1211 . . . 2” of the second production node and determines that the hierarchical identifiers are the same in the first and second digits. Third, the power distribution control apparatus sequentially compares the digits of the hierarchical identifier “12221 . . . 2” of the demand node with digits of the hierarchical identifier “12211 . . . 2” of the third production node and determines that the is hierarchical identifiers are the same in the first, second and third digits. Thus, the power distribution control apparatus sequentially compares the digits and extracts the third production node having more matched digits from among the first to third production nodes that can accept the 80 kW power request with reference to the demand node.

The power distribution control apparatus extracts distribution nodes on the distribution routes from the production node to the demand node using the hierarchical identifier of the demand node and the hierarchical identifier of the production node (S603). According to an example embodiment of the present invention, if the hierarchical identifier of the production node is “1211 . . . 2” and the hierarchical identifier of the demand node that has made the power request is “12221 . . . 2,” the power distribution control apparatus sequentially compares a power distribution route identifier of the hierarchical identifier of the demand node and a power distribution route identifier of the hierarchical identifier of the production node, from a top layer. If at least one distribution route is mismatched, the power distribution control apparatus extracts the third digit corresponding to a mismatched layer.

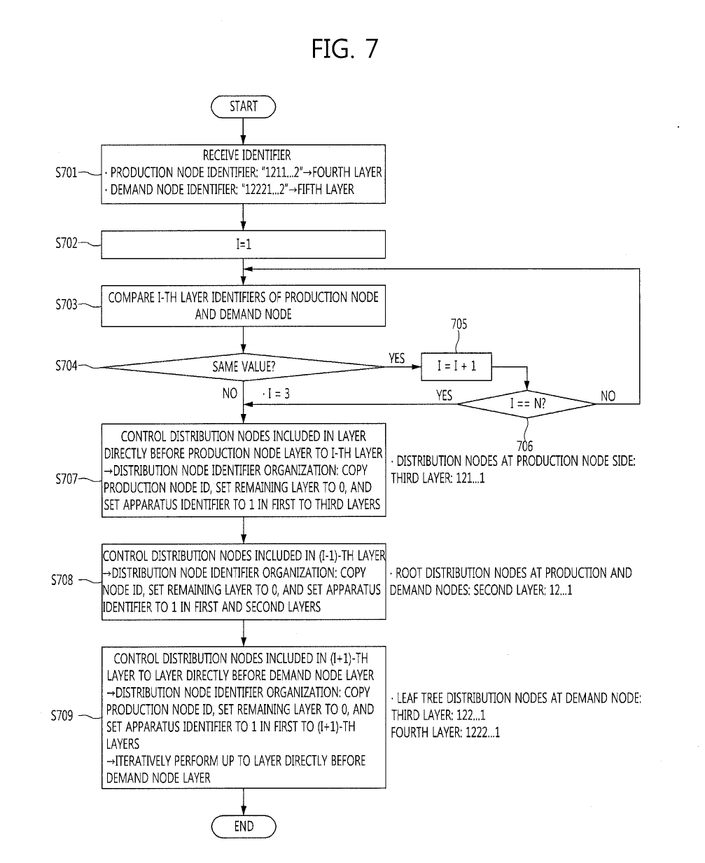

The power distribution control apparatus controls the distribution nodes on the distribution routes from the production node to the demand node using the hierarchical identifiers of the distribution nodes (S604). According to an example embodiment of the present invention, when the hierarchical identifier of the production node is “1211 . . . 2” and the hierarchical identifier of the demand node that has made the power request is “12221 . . . 2,” the power distribution control apparatus controls distribution nodes included in a layer directly before the layer including the production node to the third layer, distribution nodes included in the second layer, and distribution nodes included in the fourth layer to a layer directly before the layer including the demand node. Hereinafter, a power distribution control process for controlling distribution of electric power between the production node and the demand node according to an example embodiment of the present invention will be described in greater detail with reference to FIG. 7.

FIG. 7 is a flowchart illustrating a power distribution control process for controlling distribution of electric power between the production node and the demand node according to an example embodiment of the present invention. Referring to FIG. 7, the power distribution control apparatus extracts distribution nodes on distribution routes to control distribution of electric power from a production node having a hierarchical identifier of “1211 . . . 2” to a demand node having a hierarchical identifier of “12221 . . . 2” (S701). The power distribution control apparatus initializes a variable I used for a comparison between the hierarchical identifiers of the production node and the demand node into 1 (S702), and sequentially compares digits of the hierarchical identifier of the production node “1211 . . . 2” with digits of the hierarchical identifier “12221 . . . 2” of the demand node (S703). Here, the power distribution control apparatus compares an I-th digit of the hierarchical identifier “1211 . . . 2” of the production node of the fourth layer with an I-th digit of the hierarchical identifier “12221 . . . 2” of the demand node of the fifth layer.

The power distribution control apparatus determines whether the I-th digit of the hierarchical identifier “1211 . . . 2” of the production node of the fourth layer is the same as the I-th digit of the hierarchical identifier “12221 . . . 2” of the demand node of the fifth layer (S704). If the I-th digit of the hierarchical identifier “1211 . . . 2” of the production node of the fourth layer is the same as the I-th digit of the hierarchical identifier “12221 . . . 2” of the demand node of the fifth layer, the power distribution control apparatus increases a value of the variable I (S705) and compares the increased value of the variable I with the number N of layers in the power distribution network to determine whether the increased value of the variable I is the same as the number N of layers in the power distribution network (S706). If the increased value of the variable I is not the same as the number N of layers in the power distribution network, the power distribution control apparatus compares the I-th digit of the hierarchical identifier “1211 . . . 2” of the production node of the fourth layer with the I-th digit of the hierarchical identifier “12221 . . . 2” of the demand node of the fifth layer (S703).

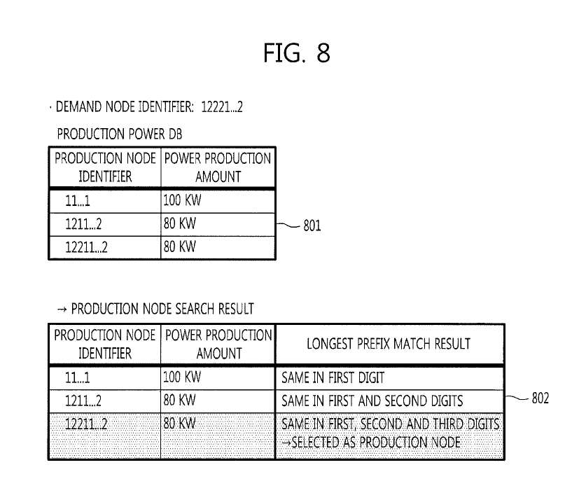

If the I-th digit of the hierarchical identifier “1211 . . . 2” of the production node of the fourth layer is not the same as the I-th digit of the hierarchical identifier “12221 . . . 2” of the demand node of the fifth layer, the power distribution control apparatus controls distribution nodes included in the third layer directly before the fourth layer, which is a production node layer, to a layer corresponding to the variable I (S707). The node control apparatus controls distribution nodes contained in the (I−1)-th layer (S708), and controls distribution nodes included in the (I+1)-th layer to a layer directly before the demand node layer (S709). Hereinafter, a process of extracting an optimal production node when there is a power request from a demand node in a smart grid according to an example embodiment of the present invention will be described in greater detail with reference to FIG. 8.

FIG. 8 is a flowchart illustrating a process of extracting an optimal production node when there is a power request from a demand node in a smart grid according to an example embodiment of the present invention.

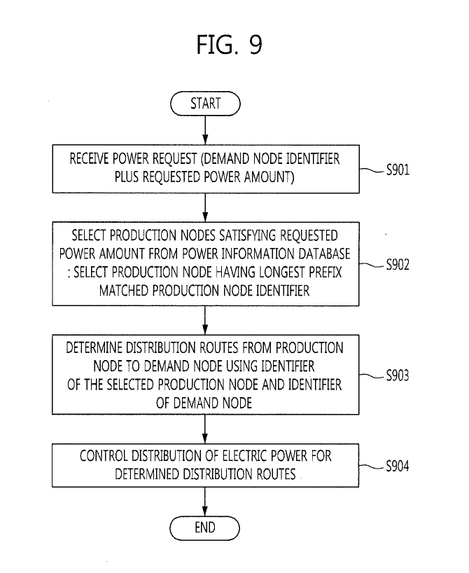

Referring to FIG. 8, when an 80 kW power request is received from a demand node having a hierarchical identifier defined as “12221 . . . 2,” the power distribution control apparatus sequentially compares digits of the hierarchical identifier of the demand node with digits of hierarchical identifiers of the production nodes that can accept the 80 kW power request among production nodes in a produced power information database 801 and extracts a production node search result 802 corresponding to the hierarchical identifier having more matched digits. First, the power distribution control apparatus sequentially compares digits of the hierarchical identifier “12221 . . . 2” of the demand node with digits of the hierarchical identifier “11 . . . 1” of the first production node and determines that the hierarchical identifiers are the same in the first digit. Second, the power distribution control apparatus sequentially compares the digits of the hierarchical identifier “12221 . . . 2” of the demand node with digits of the hierarchical identifier “1211 . . . 2” of the second production node and determines that the hierarchical identifiers are the same in the first and second digits. Third, the power distribution control apparatus sequentially compares the digits of the hierarchical identifier “12221 . . . 2” of the demand node with digits of the hierarchical identifier “12211 . . . 2” of the third production node and determines that the hierarchical identifiers are the same in the first, second and third digits. Thus, the first extractor 501 sequentially compares the digits of the hierarchical identifier of the demand node with the digits of the hierarchical identifiers of the first to third production nodes that can accept the 80 kW power request with reference to the demand node and extracts the third production node having more matched digits. Hereinafter, a process of extracting an optimal production node among production nodes stored in the produced power information database when the power distribution control apparatus receives a power request from a demand node and controlling distribution of electric power between the demand node and the production node according to an example embodiment of the present invention will be described in greater detail with reference to FIG. 9.

FIG. 9 is a flowchart illustrating a process of extracting an optimal production node among production nodes stored in the produced power information database when the power distribution control apparatus receives a power request from a demand node and controlling distribution of electric power between the demand node and the production node according to an example embodiment of the present invention.

Referring to FIG. 9, the power distribution control apparatus receives the power request from the demand node (S901), searches the produced power information database for production nodes satisfying a power amount requested by the power request, and selects the production node closest to the demand node from among the searched production nodes (S902). The power distribution control apparatus determines distribution routes from the production node to the demand node using the hierarchical identifier of the production node closest to the demand node and the hierarchical identifier of the demand node (S903), and controls distribution of electric power for the determined distribution routes (S904). According to an example embodiment of the present invention, when power production amounts of the first to third production nodes stored in the produced power information database are 100 kW, 80 kW, and 50 kW, respectively, and the power distribution control apparatus receives a request for 80 kW power from the demand node (S901), the power distribution control apparatus searches for the first and second production nodes that produce at least the 80 kW requested by the demand node. To select the production node closest to the demand node from among the first and second searched production nodes, first, the power distribution control apparatus sequentially compares the digits of the hierarchical identifier “11 . . . 1” of the first production node with the digits of the hierarchical identifier “12221 . . . 2” of the demand node and determines that the hierarchical identifiers are the same in the first digits. Second, the power distribution control apparatus sequentially compares the digits of the hierarchical identifier “12211 . . . 2” of the second production node with the digits of the hierarchical identifier “12221 . . . 2” of the demand node, determines that the hierarchical identifiers are the same in the first, second and third digits, extracts the second production node having more matched digits as an optimal production node, extracts distribution nodes on distribution routes from the second production node to the demand node, and controls distribution of electric power (S904).

With the method of managing identifiers using an identifier hierarchical structure in the smart grid system and the apparatus therefor according to example embodiments of the present invention, the nearest optimal production node can be efficiently selected in response to a real-time power request without separately managing information on a distribution route for each apparatus, the distribution routes from the production node to the demand node can be automatically recognized, and distribution of electric power can be automatically controlled in real time.

While the example embodiments of the present invention and their advantages have been described in detail, it should be understood that various changes, substitutions and alterations may be made herein without departing from the scope of the invention.

Brief Description of Reference Numerals

| | |
|---|---|
| 501: first extractor | 502: second extractor |
| 503: controller | |

What is claimed is:

1. A power production, demand and distribution apparatus in a smart grid network, the apparatus comprising:
a definition unit configured to define a hierarchical identifier capable of hierarchically identifying power distribution routes along a power distribution path having a tree structure, the hierarchical identifier including a power distribution route identifier for hierarchically identifying distribution routes of N layers (N is a natural number) and an apparatus identifier for uniquely identifying an apparatus in a last layer.

2. An apparatus for controlling distribution of electric power, comprising:
a first extractor configured to extract a production node capable of accepting a power request with reference to at least one demand node using hierarchical identifiers of the production node and the demand node when the power request is received from the demand node, the demand node being connected to a plurality of layers via distribution nodes;
a second extractor configured to extract distribution nodes on distribution routes from the production node to the demand node using the hierarchical identifier of the demand node and the hierarchical identifier of the production node; and
a controller configured to control the distribution nodes on the distribution routes from the production node to the demand node using hierarchical identifiers of the distribution nodes.

3. The apparatus of claim 1, wherein the first extractor sequentially compares digits of the hierarchical identifier of the demand node with digits of hierarchical identifiers of production nodes in a produced power information database, and extracts the production node corresponding to the hierarchical identifier having more matched digits.

4. The apparatus of claim 1, wherein the second extractor sequentially compares a power distribution route identifier of the hierarchical identifier of the demand node with a power distribution route identifier of the hierarchical identifier of the production node, from a top layer, and extracts a first distribution route point at which the production node and the demand node are branched on the distribution route.

5. The apparatus of claim 3, wherein the second extractor extracts an I-th digit (I is a natural number) corresponding to a mismatched layer if at least one distribution route is not the same as a result of the comparison.

6. The apparatus of claim 4, wherein the controller controls distribution nodes included in a layer directly before a layer including the production node to an I-th layer, distribution nodes included in an (I−1)-th layer, and distribution nodes included in an (I+1)-th layer to a layer directly before a layer including the demand node.

7. A method of controlling distribution of electric power in a power distribution control apparatus, the method comprising:
receiving a power request from at least one demand node connected to a plurality of layers via distribution nodes;
extracting a production node capable of accepting the power request with reference to the demand node using hierarchical identifiers of the production node and the demand node;
extracting distribution nodes on distribution routes from the production node to the demand node using the hierarchical identifier of the demand node and the hierarchical identifier of the production node; and
controlling the distribution nodes on the distribution routes from the production node to the demand node using hierarchical identifiers of the distribution nodes.

8. The method of claim 7, wherein the extracting of the production node comprises sequentially comparing digits of the hierarchical identifier of the demand node with digits of hierarchical identifiers of production nodes in a produced power information database, and extracting the production node corresponding to the hierarchical identifier having more matched digits.

9. The method of claim 7, wherein the extracting of the distribution nodes comprises sequentially comparing a power distribution route identifier of the hierarchical identifier of the demand node with a power distribution route identifier of the hierarchical identifier of the production node, from a top layer, and extracting a first distribution route point at which the production node and the demand node are branched on the distribution route.

10. The method of claim 9, wherein the extracting of the distribution nodes comprises extracting an I-th digit (I is a natural number) corresponding to a mismatched layer if at least one distribution route is mismatched as a result of the comparison.

11. The method of claim 10, wherein the controlling of the distribution nodes comprises controlling distribution nodes included in a layer directly before a layer including the production node to an I-th layer, distribution nodes included in an (I−1)-th layer, and distribution nodes included in an (I+1)-th layer to a layer directly before a layer including the demand node.

12. The method of claim 6, wherein the hierarchical identifier includes a power distribution route identifier and an apparatus identifier.

13. The apparatus of claim 2, wherein the first extractor sequentially compares digits of the hierarchical identifier of the demand node with digits of hierarchical identifiers of production nodes in a produced power information database, and extracts the production node corresponding to the hierarchical identifier having more matched digits.

14. The apparatus of claim 2, wherein the second extractor sequentially compares a power distribution route identifier of the hierarchical identifier of the demand node with a power distribution route identifier of the hierarchical identifier of the production node, from a top layer, and extracts a first distribution route point at which the production node and the demand node are branched on the distribution route.
